(19) United States
(12) Patent Application Publication
(10) Pub. No.: US 2016/0134158 A1
(43) Pub. Date: May 12, 2016

(54) UNIVERSAL SOLAR POWERED DEVICE FOR PERSONAL COMPUTING DEVICES

(71) Applicant: Kimberly Kay Ridge, LaVista, NE (US)

(72) Inventor: Kimberly Kay Ridge, LaVista, NE (US)

(21) Appl. No.: 14/981,132

(22) Filed: Dec. 28, 2015

Related U.S. Application Data
(60) Provisional application No. 62/098,270, filed on Dec. 30, 2014.

(51) Int. Cl. H02J 7/35; H02J 7/00; H02S 40/38

(52) U.S. Cl. CPC H02J 7/355; H02S 40/38; H02J 7/0013; H02J 7/0052; H02J 7/007; H02J 2007/0062

(57) ABSTRACT

The various embodiments herein provide a solar based powering device with multi-device supportability comprising a solar panel, a charging circuit, a power transfer port housing and a processor. The solar panel comprises a plurality of individual photovoltaic cells connected a single power output line. The single power output line is connected to at-least one battery of at-least one personal computing device. The charging circuit is connected to the output line of the solar panel. The charging circuit controls a power output to the at-least one battery of the at-least one personal computing device. The power transfer port housing is connected with the charging circuit. The power transfer port housing provides connection between the charging circuit and the at-least one battery. The processor is connected with the charging circuit and the power transfer port housing to regulate a charging delivered to the at-least one personal computing device.

### BACKGROUND

1. Technical Field of Invention

The embodiments herein generally relate to a power device and particularly relate to a universal solar powered device connected to a plurality of personal computing devices. The embodiments herein more particularly relate to a solar powered device with ability to supply a selective amount of power to a plurality of personal computing devices.

2. Description of Related Art

A solar charger employs solar energy to supply electricity to devices or charge batteries. They are generally portable. Solar chargers can charge lead acid or Ni—Cd battery banks up to 48 V and hundreds of ampere-hours (up to 4000 Ah) capacity. Such type of solar charger setups generally uses an intelligent charge controller. A series of solar cells are installed in a stationary location (i.e.: rooftops of homes, base-station locations on the ground etc.) and can be connected to a battery bank to store energy for off-peak usage. They can also be used in addition to mains-supply chargers for energy saving during the daytime. To utilize the solar panel for compact devices efficiently many developments have been attempted.

Out of most generally followed design of the solar panels for compact devices, one prior art discloses a solar powered recharging device for providing an additional charging capability for a personal communication device. The inventive device includes a solar panel that is secured to a surface of the personal communication device or a battery power source. The solar panel is in communication with the personal communication device or a battery power source that is electrically coupled to the personal communication device for continuously supplying power the personal communication device or the battery power source.

Further, additional attempts have been shown in prior arts disclosing a device for powering electrical digital pulse discharge applications comprises one or more solar energy conversion modules and a load-levelling circuit that is comprised of at least one capacitor.

However, the conventional solar powering devices have a limitation of charging only one device at a time. Further, the conventional solar powering devices are implementable only as separate charging unit, hence has to be carried separately.

In the view of foregoing, there is a need for a solar based powering device with multi-device load device supportability. Also there is a need for a universal solar based powering device with power management mechanism for optimum power transfer to load devices. Further there is a need for a solar powering device with selective integrate-ability to a personal computing device.

The above mentioned shortcomings, disadvantages and problems are addressed herein, as detailed below.

### SUMMARY OF THE INVENTION

The primary objective of the embodiment herein is to provide a solar based powering device with multi-device load device supportability.

Another object of the embodiments herein is to provide a universal solar based powering device with power management mechanism for optimum power transfer to load devices.

Yet another object of the embodiment herein a solar powering device with selective integrate-ability to a personal computing device.

The various embodiments herein provide a solar based powering device with multi-device supportability comprising a solar panel, a charging circuit, a power transfer port housing and a processor. The solar panel comprises a plurality of individual photovoltaic cells connected to a single power output line. The single power output line is connected to at-least one battery of at-least one personal computing device. The charging circuit is connected to the output line of the solar panel. The charging circuit controls a power output to the at-least one battery of the at-least one personal computing device. The power transfer port housing is connected with the charging circuit. The power transfer port housing provides connection between the charging circuit and the at-least one battery. The processor is connected with the charging circuit and the power transfer port housing to regulate a charging voltage delivered to the at-least one battery of the at-least one personal computing device.

According to an embodiment herein, the power transfer port housing comprises a plurality of power output ports for connecting a plurality of personal computing devices.

According to an embodiment herein, the plurality of power output ports comprises at-least one mini-USB port 3.0, at-least one mini-USB port 2.0, at-least one two pin power socket and at-least one three pin power socket.

According to an embodiment herein, each port is connected in parallel to an output node of the charging circuit. Each output node of the charging circuit comprises a variable resistor with controllable resistance range.

According to an embodiment herein, the charging circuit comprises a dedicated cut-off switch for an output node connected to one power output port.

According to an embodiment herein, the processor detects a battery status of a personal computing device acting as a load. The processor regulates an output voltage of the charging circuit and a charging time for the personal computing device.

According to an embodiment herein, the processor regulates the output voltage by regulating a resistance of the output node parallel to the power output port. The power output port is connected to said personal computing device.

According to an embodiment herein, the processor regulates an opening and closing of the cut-off switch connected to the output node parallel to the power output port. The power output port is connected to said personal computing device.

According to an embodiment herein, the device is detachable integrate-able to a personal computing device.

According to an embodiment herein, the personal computing device comprises a cellular phone, a Smartphone, a Laptop and a tablet.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of the solar powering device, according to an embodiment herein.

FIG. 2 illustrates an integration of the solar powering device with a personal computing device, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

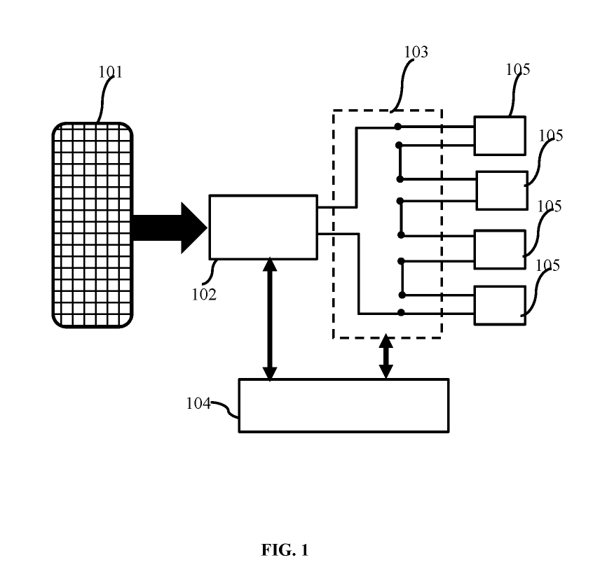

FIG. 1 illustrates a block diagram of the solar powering device, according to an embodiment herein. With respect to FIG. 1, the solar based powering device 100 with multi-device supportability comprises a solar panel 101, a charging circuit 102, a power transfer port housing 103 and a processor 104. The solar panel 101 comprises a plurality of individual photovoltaic cells connected to a single power output line. The single power output line is connected to at-least one battery 105 of at-least one personal computing device. The charging circuit 102 is connected to the output line of the solar panel 101. The charging circuit 102 controls a power output to the at-least one battery of the at-least one personal computing device. The power transfer port housing 103 is connected with the charging circuit 102. The power transfer port housing 103 provides connection between the charging circuit and the at-least one battery. The processor 104 is connected with the charging circuit 102 and the power transfer port housing 103 to regulate a charging voltage delivered to the at-least one battery of the at-least one personal computing device.

According to an embodiment herein, the power transfer port housing comprises a plurality of power output ports for connecting a plurality of personal computing devices.

According to an embodiment herein, the plurality of power output ports comprises at-least one mini-USB port 3.0, at-least one mini-USB port 2.0, at-least one two pin power socket and at-least one three pin power socket.

According to an embodiment herein, each port is connected in parallel to an output node of the charging circuit. Each output node of the charging circuit comprises a variable resistor with controllable resistance range.

According to an embodiment herein, the charging circuit comprises a dedicated cut-off switch for an output node connected to one power output port.

According to an embodiment herein, the processor detects a battery status of a personal computing device acting as a load. The processor regulates an output voltage of the charging circuit and a charging time for the personal computing device.

According to an embodiment herein, the processor regulates the output voltage by regulating a resistance of the output node parallel to the power output port. The power output port is connected to said personal computing device.

According to an embodiment herein, the processor regulates an opening and closing of the cut-off switch connected to the output node parallel to the power output port. The power output port is connected to said personal computing device.

According to an embodiment herein, the device is detachable integrate-able to a personal computing device.

According to an embodiment herein, the personal computing device comprises a cellular phone, a Smartphone, a Laptop and a tablet.

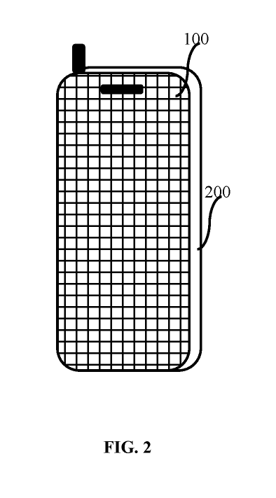

FIG. 2 illustrates an integration of the solar powering device with a personal computing device, according to an embodiment herein. With respect to FIG. 2, the solar powering device 100 is integrated to a body of the personal computing device 200 in such a way that the solar panel 101 faces direct light. The solar powering device 100 is whether detachable in nature or constitute an integral part of the personal computing device 200 depending upon an industrial manufacturing and user preference.

The present solar powering device allows intelligently distributes the power to its load device resulting in an efficient charging. For example—a laptop and a mobile device is connected to the solar powering device. While the laptop has 25% of its battery charged, the mobile device has 10% charged level. So the solar powering device senses an optimum battery capacity of both the devices and required power by the laptop and the mobile device. After processing the optimum and required battery capacity, the solar powering device charges both the loads in a way so that they reach 30% of charging at the same time.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

What is claimed is:

1. A solar based powering device with multi-device supportability comprising:
a solar panel, wherein the solar panel comprises a plurality of individual photovoltaic cells connected to a single power output line, wherein the single power output line is connected to at-least one battery of at-least one personal computing device;
a charging circuit, wherein the charging circuit is connected to the output line of the solar panel, wherein the charging circuit controls a power output to the at-least one battery of the at-least one personal computing device;
a power transfer port housing, wherein the power transfer port housing is connected with the charging circuit, wherein the power transfer port housing provides connection between the charging circuit and the at-least one battery;
a processor, wherein the processor is connected with the charging circuit and the power transfer port housing to regulate a charging voltage delivered to the at-least one battery of the at-least one personal computing device.

2. The device according to claim 1, wherein the power transfer port housing comprises a plurality of power output ports for connecting a plurality of personal computing devices.

3. The device according to claim 2, wherein the plurality of power output ports comprises at-least one mini-USB port 3.0, at-least one mini-USB port 2.0, at-least one two pin power socket and at-least one three pin power socket.

4. The device according to claim 2, wherein each port is connected in parallel to an output node of the charging circuit, wherein each output node of the charging circuit comprises a variable resistor with controllable resistance range.

5. The device according to claim 1, wherein the charging circuit comprises a dedicated cut-off switch for an output node connected to one power output port.

6. The device according to claim 1, wherein the processor detects a battery status of a personal computing device acting as a load, wherein the processor regulates an output voltage of the charging circuit and a charging time for the personal computing device.

7. The device according to claim 6, wherein the processor regulates the output voltage by regulating a resistance of the output node parallel to the power output port, wherein the power output port is connected to said personal computing device.

8. The device according to claim 6, wherein the processor regulates an opening and closing of the cut-off switch connected to the output node parallel to the power output port, wherein the power output port is connected to said personal computing device.

9. The device according to claim 1 is detachable integrate-able to a personal computing device.

10. The device according to claim 1, wherein the personal computing device comprises a cellular phone, a Smartphone, a Laptop and a tablet.
